(19) United States
(12) Patent Application Publication
(10) Pub. No.: US 2023/0012023 A1
(43) Pub. Date: Jan. 12, 2023

(54) AEROSOL PROVISION SYSTEM

(71) Applicant: Nicoventures Trading Limited, London (GB)

(72) Inventors: Junior Kabirat, London (GB); Colin Dickens, London (GB)

(21) Appl. No.: 17/780,118

(22) PCT Filed: Nov. 27, 2020
(86) PCT No.: PCT/EP2020/083805

§ 371 Date: May 26, 2022

(30) Foreign Application Priority Data
Nov. 29, 2019 (GB) 1917476.2

(51) Int. Cl. A24F 40/30; A24F 40/20; A24F 40/42; A24F 40/46; A24F 40/465; A24F 40/57; A24F 40/53; A24F 40/65; H05B 1/02

(52) U.S. Cl. CPC A24F 40/30; A24F 40/20; A24F 40/42; A24F 40/46; A24F 40/465; A24F 40/57; A24F 40/53; A24F 40/65; H05B 1/0227; H05B 2203/005

(57) ABSTRACT

An aerosol provision system including a consumable having a plurality of regions of aerosol generating material, and a heater comprising a plurality of heating elements, each heating element corresponding to a region of the plurality of regions of aerosol generating material, wherein in use the heater is arranged to controllably heat at least two of the plurality of regions of aerosol generating material to produce a personalised aerosol for inhalation.

### RELATED APPLICATION INFORMATION

The present application is a National Phase entry of PCT Application No. PCT/EP2020/083805, filed Nov. 27, 2020, which claims priority from GB Patent Application No. 1917476.2, filed Nov. 29, 2019, each of which is hereby fully incorporated herein by reference.

### TECHNICAL FIELD

The present invention relates to an aerosol provision system, a consumable for use in an aerosol provision system, a method of providing an aerosol and an aerosol provision means.

### BACKGROUND

Aerosol provision systems are known. Common systems use heaters to create an aerosol from a suitable medium which is then inhaled by a user. Often the medium used needs to be replaced or changed to provide a different aerosol for inhalation. This can lead to a user needing to open the system or to access inner components of the system. Personalized aerosols are not provided by common aerosol provision systems.

The present invention is directed toward solving or mitigating some of the above identified issues.

### SUMMARY

Aspects of the invention are defined in the accompanying claims.

In accordance with a first aspect described herein, there is provided an aerosol provision (AP) system comprising: a consumable for the AP system comprising a plurality of regions of aerosol generating material; and a heater comprising a plurality of heating elements, each heating element corresponding to a region of the plurality of regions of aerosol generating material. In use the heater is arranged to controllably heat at least two of the plurality of regions of aerosol generating material to produce a personalized aerosol for inhalation.

In accordance with a second aspect described herein, there is provided an aerosol provision (AP) comprising: a consumable for the AP system, the consumable comprising a carrier support and a plurality of portions of aerosol generating material arranged on the carrier support; and a heater comprising a plurality of heating elements, each heating element corresponding to a portion of the plurality of portions of aerosol generating material arranged on the carrier support. In use the heater is arranged to controllably heat at least two of the plurality of portions of aerosol generating material to produce a personalized aerosol for inhalation.

In an embodiment, a first heating element heats a first portion of aerosol generating material for a first amount of time and a second heating element heats a second portion of aerosol generating material for a second amount of time, wherein the first amount of time and the second amount of time are different.

In an embodiment, a first heating element heats a first portion of aerosol generating material at a first power level and a second heating element heats a second portion of aerosol generating material at a second power level, wherein the first power level and the second power level are different power levels.

In an embodiment, there is provided a control unit wherein the control unit is arranged to receive a command in relation to the production of an aerosol and control the activation of specific heating elements of the heater so as to produce an aerosol.

In an embodiment, there is provided: a movement system arranged to provide relative movement between the consumable and at least two of the plurality of heating elements, the system arranged so that at least two of the plurality of heating elements move relatively to the consumable to selectively heat a respective at least two of the plurality of portions.

In an embodiment, there is provided the movement system is arranged to provide movement to the consumable.

In an embodiment, prior to or during an inhalation session, the heater is moved relative to the consumable by the movement system to selectively heat at least two of the plurality of portions. In an embodiment, the plurality of portions of aerosol generating material is in the form of at least one of a gel and a solid.

In an embodiment, the plurality of portions of aerosol generating material are on one side of the carrier support and the heater faces a different side of the carrier support.

In an embodiment, the carrier support is formed of at least one of: paper or cellulose.

In an embodiment, the carrier support is substantially in the form of a rectangle and the plurality of portions of aerosol generating material are arranged in rows.

In accordance with a third aspect described herein, there is provided a system, comprising the AP system of any one of the preceding claims, and a substrate identification means. The substrate identification means comprises: an input mechanism operable to receive an identifier corresponding to a substrate type; a configuration obtaining means operable to obtain data indicating the configuration of the plurality of regions of aerosol generating material on the identified substrate type; and a control setting means operable to modify heating control of at least two of the plurality of regions of aerosol generating material in response to the indicated configuration of the substrate.

In an embodiment, there is provided a mobile phone comprises the substrate identification means, and the AP system comprises a wireless communication means operable to communicate with the mobile phone.

In accordance with a fourth aspect described herein, there is provided a consumable for use in an aerosol provision (AP) system, the consumable comprising a plurality of regions of aerosol generating material, wherein the plurality of regions of aerosol generating material are arranged in a series of rows, and wherein the aerosol generating material comprises at least one of a gel and a solid.

In accordance with a fifth aspect described herein, there is provided a consumable for use in an aerosol provision (AP) system, the consumable comprising a carrier support and a plurality of portions of aerosol generating material, wherein the plurality of portions of aerosol generating material are arranged in a series of rows on the carrier support, and wherein the aerosol generating material comprises at least one of a gel and a solid.

In an embodiment, the plurality of portions of aerosol generating material are arranged on one side of the carrier support.

In accordance with a sixth aspect described herein, there is provided a method of providing an aerosol comprising: providing a heater comprising a plurality of heating elements; providing a consumable comprising a plurality of regions of aerosol generating material; and heating at least two of the plurality of regions of aerosol generating material to produce a personalized aerosol, wherein the aerosol generating material comprises at least one of a gel and a solid.

In an embodiment, the method of providing an aerosol further comprises moving at least one heating element of the heater relative to the consumable prior to heating at least one of the plurality of portions of aerosol generating material.

In an embodiment the method further comprises heating at least some of a plurality of heating elements to produce a personalized aerosol from a corresponding some of the plurality of regions of aerosol generating material, wherein each of the plurality of regions of aerosol generating material has a corresponding heating element in the plurality of heaters.

In accordance with a seventh aspect described herein, there is provided an aerosol provision (AP) means comprising: a consumable for the AP system comprising a plurality of regions of aerosol generating material; and heating means comprising a plurality of heating elements, each heating element corresponding to a region of the plurality of regions of aerosol generating material, wherein in use the heating means is arranged to controllably heat at least two of the plurality of regions of aerosol generating material to produce a personalized aerosol for inhalation. In accordance with an eighth aspect described herein, there is provided an aerosol provision (AP) system comprising: a consumable for the AP system, comprising a plurality of portions of aerosol generating material; and a heater comprising a plurality of heating zones, each heating zone corresponding to a portion of the plurality of portions of aerosol generating material, wherein in use the heater is arranged to controllably heat at least two of the plurality of portions of aerosol generating material to produce a personalized aerosol for inhalation.

In an embodiment, the plurality of zones are provided on a single heating structure.

In an embodiment, the heater comprises at least one heating structure, wherein each heating structure comprises a plurality of heating zones.

In accordance with a ninth aspect described herein, there is provided a method of providing an aerosol, comprising: providing a heater comprising a plurality of heating zones; providing a consumable comprising a plurality of regions of aerosol generating material; and heating at least two of the plurality of regions of aerosol generating material to produce a personalized aerosol.

In an embodiment, the plurality of zones are provided on a single heating structure.

In an embodiment, the heater comprises at least one heating structure, wherein each heating structure comprises a plurality of heating zones.

### DESCRIPTION OF DRAWINGS

The present teachings will now be described by way of example only with reference to the following figures in which like parts are depicted by like reference numerals:

FIG. 1 is a schematic sectional view of a consumable for use in an aerosol provision system according to an example;

FIG. 2 is a schematic sectional view of a consumable for use in an aerosol provision system according to an example;

FIG. 3 is a schematic sectional view of a portion of an aerosol provision system according to an example; and,

FIG. 4 is a schematic sectional view of a portion of an aerosol provision system according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

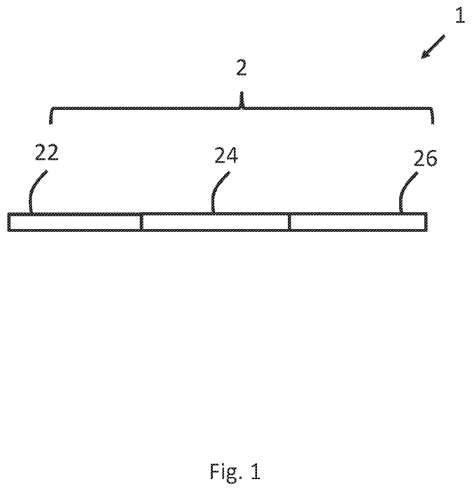

FIG. 1 illustrates a schematic view of a consumable 1 for use in an aerosol provision system. The consumable 1 as illustrated in this example is designed for use in an aerosol provision system which may be designed to simulate a cigarette and therefore as a non-limiting example may have a substantially cylindrical shape and be approximately the same size as a cigarette. In other embodiments, the consumable 1 may have a different shape, such as a substantially planar shape, a substantially cuboid shape, a substantially spherical shape, a trapezoidal shape, or other shape.

The consumable 1 has a plurality of regions of aerosol generating material 2. The aerosol generating material 2 has three regions 22, 24, 26 illustrated. In use, a heater of an aerosol provision system may selectively heat one, some or all the regions 22, 24, 26 simultaneously or separately. The regions 22, 24, 26 of the aerosol generating material 2 may be regions 22, 24, 26 of the same aerosol generating material such as tobacco, or may be regions 22, 24, 26 of different aerosol generating material such as nicotine, glycol and an acid. These may be controllably heated to provide a personalized aerosol. The term region may be used herein to refer to a portion of a larger element of, for example, aerosol generating material or the like. In examples, the term portion may be used in a similar manner to the term region. A portion may be an amount of, for example, aerosol generating material which is suitable to provide a set amount of aerosol for one or more puffs (or sessions) from an aerosol provision system. The example of a consumable 1 with regions 22, 24, 26 of aerosol generating material 2 may be used in any of the examples of an aerosol provision system provided herein.

The heater may comprise one or more electrically resistive heaters, including for example one or more nichrome resistive heater(s) and/or one or more ceramic heater(s). The one or more heaters may comprise one or more induction heaters which includes an arrangement comprising one or more susceptors which may form a chamber into which the consumable 1 or another article comprising aerosolizable material is inserted or otherwise located in use. Alternatively or in addition, one or more susceptors may be provided in the consumable 1 or in the aerosolizable material. Other heating arrangements may also be used.

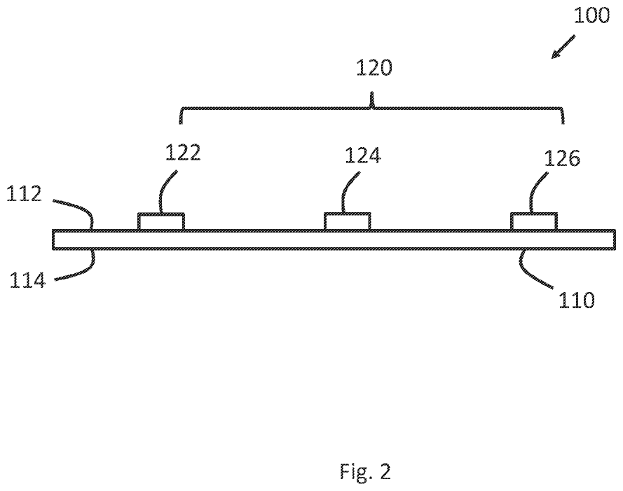

FIG. 2 illustrates a schematic view of a consumable 100 for use in an aerosol provision system. The consumable 100 as illustrated in this example is designed for use in an aerosol provision system which may be designed to simulate a cigarette and therefore as a non-limiting example may have a substantially cylindrical shape and be approximately the same size as a cigarette.

The consumable 100 has a carrier support 110. The consumable 100 has plurality of portions of aerosol generating material 120 arranged on the carrier support 110. The plurality of portions of aerosol generating material 120 may be arranged in a series of one or more rows on the carrier support 110. In the example shown in FIG. 2, the plurality of portions of aerosol generating material 120 comprises three portions of aerosol generating material (122, 124, 126). The portions (122, 124, 126) may be arranged in any arrangement. The portions may be considered to be discrete deposits of aerosol generating material. Portions may be of a uniform size, or may be of a different size as described later herein. The portions may be placed in any predetermined configuration. The plurality of portions of aerosol generating material 120 may be arranged exclusively on one side 112 of the carrier support 110, or optionally with portions also arranged on the other side 114 of the carrier support 110. In the example shown the carrier support 110 has two sides, however there is no requirement for the carrier support 110 to be restricted to such a shape, for example the carrier support 110 may be substantially cylindrical shape, triangular shape, square tube shape or the like. The carrier support 110 in any of these examples may be hollow or solid. In the example wherein the carrier support 110 has a plurality of sides, the portions 120 may be constrained to only one side or to all but one side of the carrier support 110. In an alternate example, the portions 120 may be arranged on all sides of the carrier support 110. In the arrangement wherein the heater is on one side of the carrier support 110 and the aerosol generating material 120 is on another side (or other sides), heat may be transferred from the heater through the carrier support 110 to aerosol generating material 120 on other sides. The material of the carrier support 110 may be chosen so as to transmit heat effectively from the heater to the aerosol generating material 120.

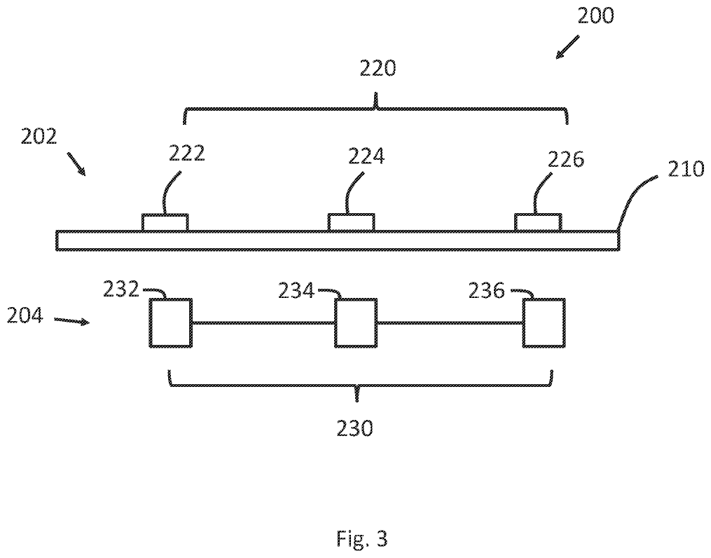

FIG. 3 shows a portion of an aerosol provision system 200 according to an example. The aerosol provision (AP) system 200 comprises a consumable 202 for an AP system 200. The consumable 202 has similar features to the consumable 100 shown in the example of FIG. 2 and described above. These features will not be repeated here.

The AP system 200 also has a heater 204 comprising a plurality of heating elements 230. In the example of FIG. 3, each of the heating elements 232, 234, 236 corresponds to a portion 222, 224, 226 of the plurality 220 of portions of aerosol generating material arranged on the carrier support 210. In use, the heater 204 is arranged to controllably heat at least two of the plurality 220 of portions of aerosol generating materials to produce a personalized aerosol for inhalation.

In the example shown in FIG. 3, each of the heating elements 232, 234, 236 may provide thermal energy to a specific portion 222, 224, 226 to enable aerosolization of the aerosol generating material. During use of the AP system 200, one or more of the heating elements 232, 234, 236 may be activated so as to produce aerosol from one or more of the portions 220 of aerosol generating material.

The AP system 200 may have a power chamber (not shown) comprising a power source for supplying power to the heater 230. The heater 230 in the described example may be an electrically resistive heater 230. However, in other examples, the heater 230 may be a chemically activated heater which may or may not operate via exothermic reactions or the like. The heater 230 may be part of an inductive heating system, wherein the heater 230 is the source of energy for inductive heating, such as a coil of copper wire, and the carrier support 210 may be or may contain a susceptor or the like. The susceptor may for example be a sheet of aluminum foil or the like. In an example, the portions 222, 224, 226 of aerosol generating material may each comprise a susceptor. A susceptor may be partly or fully integrated within a portion. The portions 222, 224, 226 of aerosol generating material may each comprise a substantially similar susceptor, or alternatively one or more of the portions 222, 224, 226 may comprise a substantially different susceptor. In an example the heating elements 232, 234, 236 are sources for inductive heating, for example comprising induction coils. In an example, the heating elements 232, 234, 236 are not all the same type of heating element. In an example, at least one heating element 232, 234, 236 of the heater 230 is an electrically resistive heater, another heating element 232, 234, 236 is a chemically activated heater and optionally another heating element 232, 234, 236 is an inductive heater, wherein the inductive heater heating element 232, 234, 236 can be a source for inductive heating such as an induction coil, or alternatively the inductive heater heating element 232, 234, 236 can be a susceptor.

In an example, the plurality of portions 220 and the plurality of heating elements 230 may be different in number. For example, one heating element may heat two portions if it is desired for these to always be heated together. Conversely, two heating elements may be used for respective portions in one instance, but may be used in concert to heat a larger portion (for example for a major component of the aerosol, or one that is consumed more frequently) in another instance. Alternatively or in addition, the carrier support may be physically moveable laterally with respect to the heater to newly position one or more different portions over a respective heater, thereby enabling a new mixing palette. Each portion 220 on the consumable 202 may have its own heater element located (e.g. directly) below when inserted into the system 200. When inserted, the consumable 202 will be fixed in place to prevent movement and ensure good contact between the heater 230 and the portion 220. In an example, the plurality of portions 220 may be a sample or reservoir of aerosolizable material, which may include nicotine and nicotine-containing substances.

In use, the user may activate, or result in the activation of, particular heating elements 232, 234, 236 so that specific portions 222, 224, 226 of aerosol generating material are heated to produce aerosol. The user may therefore select the contributory materials to heat to produce an aerosol, thereby providing a personalized aerosol. “Personalized aerosol” is therefore used herein to mean user-selected or, at least in some way, tailored to the desires of the user.

In use, heating elements 232, 234, 236 may be activated at the same time or may be operated with a delay between operation. This may be used to enable particular notes of an aerosol to be more or less prevalent in the overall aerosol or smoking session. In an example, a particular heating element 232 may heat a particular portion 222, e.g. a tobacco portion, at a first time to produce a tobacco aerosol for inhalation. This may be shortly followed by a different heating element 234 heating a menthol portion 224 at a second time to follow the tobacco aerosol with a menthol aerosol with which the user desires to conclude the smoking session.

Varying heating profiles may be supplied to a plurality of portions 222, 224, 226 of aerosol generating material to provide a personalized aerosol. Complex combinations of profiles may be utilized to produce a highly specific combination of blends and release time so that the aerosol is highly personalizable.

In an example, a first heating element 232 heats a first portion 222 of aerosol generating material for a first amount of time and a second heating element 234 heats a second portion 224 of aerosol generating material for a second amount of time, wherein the first amount of time and the second amount of time are different. This enables greater personalization of aerosol. This also enables production of aerosol with different notes during the smoking session.

In an example, a first heating element 232 heats a first portion 222 of aerosol generating material at a first power level and a second heating element 234 heats a second portion 224 of aerosol generating material at a second power level, wherein the first power level and the second power level are different power levels. This further enables greater personalization of a produced aerosol. As the aerosol released will be related to the power at which the heater 230 operates, flavors can be released at different times in the session which, as above, leads to a level of control over the production of different notes within the smoking session.

The power level may be related to the power at which the specific heating element 232, 234, 236 is operated, the rate of heat delivery or the temperature that the heater 230 reaches during the heating phase.

In an example, the system 200 further comprises a control unit. The control unit is arranged to receive a command in relation to the production of an aerosol and control the activation of specific heating elements 232, 234, 236 of the heater 230 so as to produce an aerosol. Selective activation of the heating elements 232, 234, 236 results in selective heating of portions 222, 224, 226 of aerosol generating material such that a personalized aerosol is produced.

The command received by the control unit may be an input by a user via a user interface on an external surface of the AP system 200. The command may be received by the control unit via a wired or wireless interface, such that the system 200 may be operated via e.g. BlueTooth® or a LAN or via a smartphone or other such device.

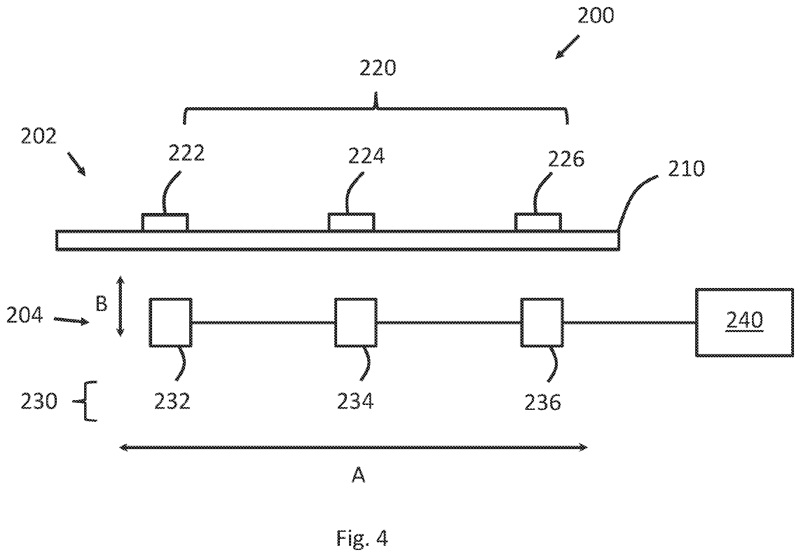

In the example shown in FIG. 4, the system 200 further comprises a movement system 240 arranged to provide relative movement between the consumable 202 and at least two of the plurality of heating elements 232, 234, 236. The system 200 is arranged so that at least two of the plurality of heating elements 232, 234, 236 move relatively to the consumable 202 to selectively heat a respective at least two of the plurality of portions 222, 224, 226.

The movement system 240 shown in FIG. 4 is shown as being connected to the heater 230, however, it may be connected to the consumable 202. Moving the heater 230, or parts of the heater 230, allows the individual heating elements 232, 234, 236 to be closer to their respective portions 222, 224, 226 such that the heating element 232, 234, 236 needs to emit less thermal energy to produce an aerosol from the portion 222, 224, 226. Therefore, this provides a more energy efficient system. Moving the consumable 202 instead has the further advantage that this prevents a need to move the heater 230 as the heater 230 may have some amount of electronics or the like which movement may dislodge. As such, movement of the consumable 202 reduces the likelihood of this undesirable event occurring.

The above paragraph may relate to the relative movement of the consumable 202 and the heater 230 in the direction indicated by the arrow B. The movement system 240 may alternatively or additionally provide relative motion in the direction indicated by the arrow A.

This may enable the movement system 240 to align specific heating elements 232, 234, 236 and specific portions 222, 224, 226 and reduce the distance (in the direction indicated by arrow B) between them to allow for efficient heating of selected portions 222, 224, 226 by any heating element 232, 234, 236. There is clearly no need for the movement system 240 to be constrained to proving relative movement only in orthogonal directions, as shown in the arrows of FIG. 4.

Prior to, or during, a smoking session, the heater 230 may be moved relative to the consumable 202 by the movement system 240. This ensures that the thermal energy transmitted to the aerosol generating material 220 on the carrier support 210 is efficiently transferred. By reducing the distance between the heater 230 and the item to be heated, thermal energy is more efficiently transferred and therefore less energy is needed to provide an aerosol. Similarly, in one example wherein the heater 230 may be part of an inductive heating system comprising an induction coil and the consumable 202 comprises a susceptor, by reducing the distance between the heater 230 and the item to be heated, inductive coupling between the induction coil and susceptor is increased. Energy is more efficiently transferred and therefore less energy is needed to provide an aerosol. This reduces the amount of power sent through the heater 230 per smoking session and so in turn may elongate the lifetime of the system 200. Additionally, the heater 230 may be moved away from the consumable 202 after a smoking session. In this way, the heater 230 is less likely to unintentionally heat the aerosol generating material 220 during periods of non-smoking. Therefore, less likely to deplete the consumable 202 which results in a longer lifetime of the consumable 202, and a system 200 which is cheaper to run for the user. In an example, the portions 222, 224, 226 of aerosol generating material may be in the form of at least one of a gel and a solid. A gel or a solid, unlike a liquid, would not require a reservoir to be contained within and as such reduces the cost of the device overall, by removing the requirement for an additional component. In general, the lack of requirement of the reservoir reduces the complexity of the system 200 presented herein.

In the system 200 the portions 222, 224, 226 may be of different compositions. The portions 222, 224, 226 may be any of nicotine, glycerol or an acid. Other portions may be of different flavors. In an example, a nicotine portion is heated to provide nicotine to the aerosol and the glycerol portion is heated accordingly to provide a desired cloud volume. Varying the heating provided to an acid portion alters the level of protonation of the nicotine (in the event that the nicotine portion is also heated).

The nicotine portion may contain any of a nicotine free base, nicotine benzoate, nicotine malate, nicotine pyruvate, and nicotine succinate. In a specific example there may be 10 nicotine portions, 5 glycerol portions and 4 acid portions arranged on the carrier support 210.

Arrangement of the plurality of portions of aerosol generating material 220 on one side of the carrier support 210 and the heater 230 on the other side of the carrier support 210 encourages the aerosol provided to flow in a direction that is not towards the heater 230. This reduces the amount of aerosol that may condense on the heater 230 which in turn reduces the damage caused to the heater 230 and therefore increases the lifetime of the system 200 as a whole. In an example wherein the carrier support 210 has more than two sides, the heater 230 may be arranged to face a side that does not have aerosol generating material 220 arranged on it to gain the benefit as mentioned above.

The carrier support 210 of the consumable 202 may be formed of any of paper, cellulose. The arrangement of the aerosol generating material 220 on the carrier support 210 may be in a plurality of rows. In a specific example, the aerosol generating material 220 may arranged in two rows of 3 to 5 gel or solid portions. The carrier support 210 may be in the form of a rectangle or any other suitable shape. The number of portions 222, 224, 226 on the carrier support 210 may be optimized against the number of heating elements 232, 234, 236 in the heater 230. This may be done with the viable range of movement provided to each heating element 232, 234, 236 by the movement mechanism 240. If a particular heating element can be moved so as to provide heat to e.g. 4 portions, the heater 230 may contain a number of heating elements 232, 234, 236 which is ¼ of the number of portions; more specifically, if there are 12 portions, the system 200 may have three heating elements 232, 234, 236 within the heater 230. Alternatively, the system 200 may have an equal number of portions 222, 224, 226 and heating elements 232, 234, 236 within the heater 230.

In some embodiments, the plurality of heating elements 232, 234, 236 may alternatively be referred to as a plurality of heating zones 232, 234, 236. For example, in such embodiments, the heater 204 may comprise a plurality of zones 232, 234, 236 which are provided on a single heating structure. In one example, the heater comprises a plurality of heating structures, wherein each heating structure comprises a plurality of heating zones. The plurality of heating zones 232, 234, 236 can be heated by electrical resistive heating, inductive heating, chemically activated heater, or combinations thereof. The plurality of heating zones 232, 234, 236 have similar features to the plurality of heating elements 232, 234, 236 described above. These features will not be repeated here.

In some embodiments, the non-combustible aerosol provision system is an electronic cigarette, also known as a vaping device or electronic nicotine delivery system (END), although it is noted that the presence of nicotine in the aerosolizable material is not a requirement.

In some embodiments, the non-combustible aerosol provision system is a tobacco heating system, also known as a heat-not-burn system.

In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosolizable material and a solid aerosolizable material. The solid aerosolizable material may comprise, for example, tobacco or a non-tobacco product. Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the non-combustible aerosol provision device may comprise a power source and a controller. The power source may, for example, be an electric power source.

In some embodiments, the article for use with the non-combustible aerosol provision device may comprise an aerosolizable material, an aerosol generating component, an aerosol generating area, a mouthpiece, and/or an area for receiving aerosolizable material.

In some embodiments, the aerosol generating component is a heater capable of interacting with the aerosolizable material so as to release one or more volatiles from the aerosolizable material to form an aerosol.

In some embodiments, the aerosolizable material comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In some embodiments, the substance to be delivered may be an aerosolizable material. Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosolizable material may for example comprise from about 50 wt %, 60 wt % or 70 wt % of amorphous solid, to about 90 wt %, 95 wt % or 100 wt % of amorphous solid.

In some embodiments the amorphous solid comprises a setting agent. In examples, the setting agent comprises or consists of calcium acetate, calcium formate, calcium carbonate, calcium hydrogencarbonate, calcium chloride, calcium lactate, or a combination thereof. In some examples, the setting agent comprises or consists of calcium formate and/or calcium lactate. In particular examples, the setting agent comprises or consists of calcium formate. It has been identified that, typically, employing calcium formate as a setting agent results in an amorphous solid having a greater tensile strength and greater resistance to elongation.

The amorphous solid may comprise a colorant. The addition of a colorant may alter the visual appearance of the amorphous solid. The presence of colorant in the amorphous solid may enhance the visual appearance of the amorphous solid and the aerosolizable material. By adding a colorant to the amorphous solid, the amorphous solid may be color-matched to other components of the aerosolizable material or to other components of an article comprising the amorphous solid.

A variety of colorants may be used depending on the desired color of the amorphous solid. The color of amorphous solid may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the amorphous solid with a brown appearance. In such embodiments, the color of the amorphous solid may be similar to the color of other components (such as tobacco material) in an aerosolizable material comprising the amorphous solid. In some embodiments, the addition of a colorant to the amorphous solid renders it visually indistinguishable from other components in the aerosolizable material. The colorant may be incorporated during the formation of the amorphous solid (e.g. when forming a slurry comprising the materials that form the amorphous solid) or it may be applied to the amorphous solid after its formation (e.g. by spraying it onto the amorphous solid).

In some embodiments, the gel may comprise a gelling agent. The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

The aerosolizable material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid. In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

In certain embodiments, the aerosolizable material comprises a gelling agent comprising a cellulosic gelling agent and/or a non-cellulosic gelling agent, an active substance and an acid.

In some embodiments, the aerosolizable material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosolizable material may comprise one or more cannabinoid compounds selected from the group consisting of cannabidiol (CBD) and THC (tetrahydrocannabinol).

The aerosolizable material may comprise cannabidiol (CBD).

The aerosolizable material may comprise nicotine and cannabidiol (CBD).

The aerosolizable material may comprise nicotine, cannabidiol (CBD), and THC (tetrahydrocannabinol). The aerosolizable material may comprise one or more active constituents, one or more carrier constituents and optionally one or more other functional constituents.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, or any other suitable constituent. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, cooling agents, heating agents, or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, pigment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3. The carrier constituent may comprise one or more constituents capable of forming an aerosol. In some embodiments, the carrier constituent may comprise one or more of glycerine, glycerol, propylene glycol, di ethylene glycol, tri ethylene glycol, tetraethyl ene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants. In some embodiments, the article for use with the non-combustible aerosol provision device may comprise aerosolizable material or an area for receiving aerosolizable material. In some embodiments, the article for use with the non-combustible aerosol provision device may comprise a mouthpiece. The area for receiving aerosolizable material may be a storage area for storing aerosolizable material. For example, the storage area may be a reservoir. In some embodiments, the area for receiving aerosolizable material may be separate from, or combined with, an aerosol generating area.

As noted above, portions may be of different sizes, or a plurality of portions may comprise the same material, to account for different rates of consumption of aerosol generating materials. Hence for example there may be a larger portion, or more portions, of glycol and/or tobacco than there are of other individual flavorings or ingredients.

Optionally, high-volume materials may be placed at predetermined positions on the carrier support to coincide with larger and/or more diffuse heating units for large portions, or units designed to operate in concert for multiple portions of the same material.

It will be appreciated that the above approach can provide a wide range of different aerosol compositions by control of the amount and optionally the timing of generation of respective aerosol components. Furthermore, optionally different consumables (100, 202) may be provided that include different ingredients to mix, such as from the list above. It will be appreciated that in this case, applying the same heating patterns to different consumables may result in different aerosols mixes being generated, not all of which may be desirable, and so optionally the composition of the current consumable should be notified to a control unit in charge of heating so that an appropriate mix can be generated.

Hence in an embodiment of the present invention, either the aerosol provision (AP) system itself, or typically a mobile phone in communication with the AP system, can be used to obtain the composition of portions on a given consumable. For example, a consumable or its packaging may comprise a name or code that may be entered to the AP system or phone to identify it, or may comprise a marker (such as a QR code) that may be used in conjunction with a camera on the phone (or AP system) to identify it. Other methods may also be considered, such as an RFID tag within the consumable that is read by the AP system, or any other passive or active identification scheme suitable to indicate the type of consumable being used.

Once identified, the composition of the portions on the consumable can be obtained from either local or remote storage, together with any other configuration information regarding for example preset mixes, vaporization temperatures for different portion materials, and/or any limits or correlations between portions (for example to avoid undesirable mixes), and the like. The user may then be presented with a user interface on the AP system or phone, for example providing access to preset mixes, or allowing the user to dial up or down the level and optionally the timing of one or more components of the aerosol corresponding to respective portions on the consumable. In the case of a phone, it may then relay the settings to a controller of the AP system, or may provide the control directly via a wireless signal.

Thus there has been described an aerosol provision (AP) system comprising: a consumable for the AP system, comprising: a carrier support; and, a plurality of portions of aerosol generating material arranged on the carrier support, and, a heater comprising a plurality of heating elements, each heating element corresponding to a portion of the plurality of portions of aerosol generating material arranged on the carrier support, wherein in use the heater is arranged to controllably heat at least two of the plurality of portions of aerosol generating material to produce a personalized aerosol for inhalation.

The aerosol (or vapor) provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a gel or a solid, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal. In one embodiment the heating product also comprises a filter capable of filtering the aerosol generated by heating the aerosolizable substrate.

In some embodiments the aerosolizable substrate material may comprise a vapor or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In one embodiment, a system is provided comprising the AP system as per any of the embodiments described herein, together with a substrate identification means that comprises an input mechanism (such as a user input or a camera, as described previously herein) operable to receive an identifier corresponding to a substrate type; a configuration obtaining means (such as local memory or communication means to access remote memory in an associated phone or networked storage) operable to obtain data indicating the configuration of the plurality of portions of aerosol generating material on the identified substrate type; and a control setting means (such as the AP system control unit, or the CPU of an associated mobile phone) operable to modify heating control of at least two of the plurality of portions of aerosol generating material in response to the indicated configuration of the substrate.

The AP system itself may comprise the substrate identification means, or a mobile phone may comprise the substrate identification means, whilst the AP system comprises a wireless communication means (such as BlueTooth®) operable to communicate with the mobile phone.

In order to address various issues and advance the art, the entirety of this disclosure shows by way of illustration various embodiments in which the claimed invention(s) may be practiced and provide for a superior electronic vapor provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision (AP) system comprising:
a consumable for the AP system comprising a plurality of regions of aerosol generating material; and, a heater comprising a plurality of heating elements, each heating element corresponding to a region of the plurality of regions of aerosol generating material, wherein in use the heater is arranged to controllably heat at least two of the plurality of regions of aerosol generating material to produce a personalized aerosol for inhalation.

2. An aerosol provision (AP) system comprising: a consumable for the AP system, comprising:
a carrier support; and, a plurality of portions of aerosol generating material arranged on the carrier support; and
a heater comprising a plurality of heating elements, each heating element corresponding to a portion of the plurality of portions of aerosol generating material arranged on the carrier support, wherein in use the heater is arranged to controllably heat at least two of the plurality of portions of aerosol generating material to produce a personalized aerosol for inhalation.

3. The AP system according to claim 2, wherein a first heating element heats a first portion of aerosol generating material for a first amount of time and a second heating element heats a second portion of aerosol generating material for a second amount of time, wherein the first amount of time and the second amount of time are different.

4. The AP system according to claim 2, wherein a first heating element heats a first portion of aerosol generating material at a first power level and a second heating element heats a second portion of aerosol generating material at a second power level, wherein the first power level and the second power level are different power levels.

5. The AP system according to claim 2, comprising a control unit wherein the control unit is arranged to receive a command in relation to the production of an aerosol and control the activation of specific heating elements of the heater so as to produce an aerosol.

6. The AP system according to claim 2, the system further comprising: a movement system arranged to provide relative movement between the consumable and at least two of the plurality of heating elements, the system arranged so that at least two of the plurality of heating elements move relatively to the consumable to selectively heat a respective at least two of the plurality of portions.

7. The AP system according to claim 6, wherein the movement system is arranged to provide movement to the consumable.

8. The AP system according to claim 6, wherein prior to or during an inhalation session, the heater is moved relative to the consumable by the movement system to selectively heat at least two of the plurality of portions.

9. The AP system according to claim 2, wherein the plurality of portions of aerosol generating material is in the form of at least one of a gel and a solid.

10. The AP system according to claim 2, wherein the plurality of portions of aerosol generating material are on one side of the carrier support and the heater faces a different side of the carrier support.

11. The AP system according to claim 2, wherein the carrier support is formed of at least one of: paper or cellulose.

12. The AP system according to claim 2, wherein the carrier support is substantially in the form of a rectangle and the plurality of portions of aerosol generating material are arranged in rows.

13. The AP system of claim 1, and a substrate identification means, comprising: an input mechanism operable to receive an identifier corresponding to a substrate type; a configuration obtaining means operable to obtain data indicating the configuration of the plurality of regions of aerosol generating material on the identified substrate type; and a control setting means operable to modify heating control of at least two of the plurality of regions of aerosol generating material in response to the indicated configuration of the substrate.

14. The AP system of claim 13, in which a mobile phone comprises the substrate identification means; and the AP system comprises a wireless communication means operable to communicate with the mobile phone.

15. A consumable for use in an aerosol provision (AP) system, the consumable comprising:
a plurality of regions of aerosol generating material, wherein the plurality of regions of aerosol generating material are arranged in a series of rows, and wherein the aerosol generating material comprises at least one of a gel and a solid.

16. A consumable for use in an aerosol provision (AP) system, the consumable comprising:
a carrier support, a plurality of portions of aerosol generating material, wherein the plurality of portions of aerosol generating material are arranged in a series of rows on the carrier support, and wherein the aerosol generating material comprises at least one of a gel and a solid.

17. The consumable according to claim 16, wherein the plurality of portions of aerosol generating material are arranged on one side of the carrier support.

18. A method of providing an aerosol, comprising:
providing a heater comprising a plurality of heating elements;
providing a consumable comprising a plurality of regions of aerosol generating material;
heating at least two of the plurality of regions of aerosol generating material to produce a personalized aerosol, wherein the aerosol generating material comprises at least one of a gel and a solid.

19. The method according to claim 18, wherein the method further comprises: moving at least one heating element of the heater relative to the consumable prior to heating at least one of the plurality of portions of aerosol generating material.

20. The method according to claim 18, wherein the method further comprises: heating at least some of a plurality of heating elements to produce a personalized aerosol from a corresponding some of the plurality of regions of aerosol generating material, wherein each of the plurality of regions of aerosol generating material has a corresponding heating element in the plurality of heaters.

21. An aerosol provision (AP) system comprising:
a consumable for the AP system comprising a plurality of regions of aerosol generating material; and, heating means comprising a plurality of heating elements, each heating element corresponding to a region of the plurality of regions of aerosol generating material, wherein in use the heating means is arranged to controllably heat at least two of the plurality of regions of aerosol generating material to produce a personalized aerosol for inhalation.

22. An aerosol provision (AP) system comprising:
a consumable for the AP system, comprising a plurality of portions of aerosol generating material, and, a heater comprising a plurality of heating zones, each heating zone corresponding to a portion of the plurality of portions of aerosol generating material, wherein in use the heater is arranged to controllably heat at least two of the plurality of portions of aerosol generating material to produce a personalized aerosol for inhalation.

23. The AP system of claim 22, wherein the plurality of zones are provided on a single heating structure.

24. The AP system of claim 22, wherein the heater comprises at least one heating structure, wherein each heating structure comprises a plurality of heating zones.

25. A method of providing an aerosol, comprising:
providing a heater comprising a plurality of heating zones;
providing a consumable comprising a plurality of regions of aerosol generating material;
heating at least two of the plurality of regions of aerosol generating material to produce a personalized aerosol.

26. The method according to claim 25, wherein the plurality of zones are provided on a single heating structure.

27. The method according to claim 25, wherein the heater comprises at least one heating structure, wherein each heating structure comprises a plurality of heating zones.
